(19) United States
(12) Patent Application Publication
(10) Pub. No.: US 2023/0137050 A1
(43) Pub. Date: May 4, 2023

(54) ENHANCEMENTS OF C-V2X SYNCHRONIZATION BY WWAN TIME TAGGING

(71) Applicant: QUALCOMM Incorporated, San Diego, CA (US)

(72) Inventors: Cheol Hee PARK, San Diego, CA (US); Arvind Vardarajan SANTHANAM, San Diego, CA (US); Yi QIN, Beijing (CN); Jintao HOU, Beijing (CN); Akhilesh Paresh KHEDEKAR, San Diego, CA (US)

(21) Appl. No.: 17/907,611

(22) PCT Filed: May 28, 2020
(86) PCT No.: PCT/CN2020/092782

§ 371 Date: Sep. 28, 2022

(51) Int. Cl. H04W 56/00; H04W 24/08

(52) U.S. Cl. CPC H04W 56/0015; H04W 24/08

(57) ABSTRACT

Aspects of the present disclosure provide apparatus, methods, processing systems, and computer readable mediums for synchronizing a UE's timing for sidelink communications with one or more other UEs. The techniques may be used, for example, in NR V2X systems to maintain sidelink timing synchronization when a UE is outside the coverage area of a synchronization source such as a global navigation satellite system (GNSS).

### FIELD OF THE DISCLOSURE

Aspects of the present disclosure relate to wireless communications, and more particularly, to time synchronization for device-to-device sidelink communication.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved device-to-device communications in a wireless network.

Certain aspects of this disclosure provide a method for wireless communication by a user equipment (UE). The method generally includes tagging a reference time of a synchronization source with a reference time of at least one radio access network (RAN) captured at a same time instance, deriving timing of the synchronization source based on monitored timing in the RAN, when the UE is out of coverage (OOC) of the synchronization source, and utilizing the derived timing to maintain timing synchronization for sidelink communications with one or more other UEs.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (B S) and user equipment (UE), in accordance with certain aspects of the present disclosure.

FIGS. 5A and 5B show diagrammatic representations of example vehicle to everything (V2X) systems in accordance with some aspects of the present disclosure.

FIG. 6 illustrates an example of in coverage (IC) and out of coverage (OOC) UEs, in accordance with certain aspects of the present disclosure.

FIG. 7 illustrates an example of in sync and out of sync UEs, in accordance with certain aspects of the present disclosure.

FIG. 8 illustrates example operations for wireless communications by a UE, in accordance with certain aspects of the present disclosure.

FIG. 9 illustrates an example of UE maintaining synchronization, in accordance with certain aspects of the present disclosure.

FIG. 10 illustrates an example of UE measuring timing drift, in accordance with certain aspects of the present disclosure.

FIG. 11 illustrates an example of timing drift, in accordance with certain aspects of the present disclosure.

FIG. 12 illustrates examples of UE timing synchronization, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for synchronizing a UE's timing for sidelink communications with one or more other UEs. The techniques may be used, for example, in NR V2X systems to maintain sidelink timing synchronization when a UE is outside the coverage area of a synchronization source such as a global navigation satellite system (GNSS).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (SGTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

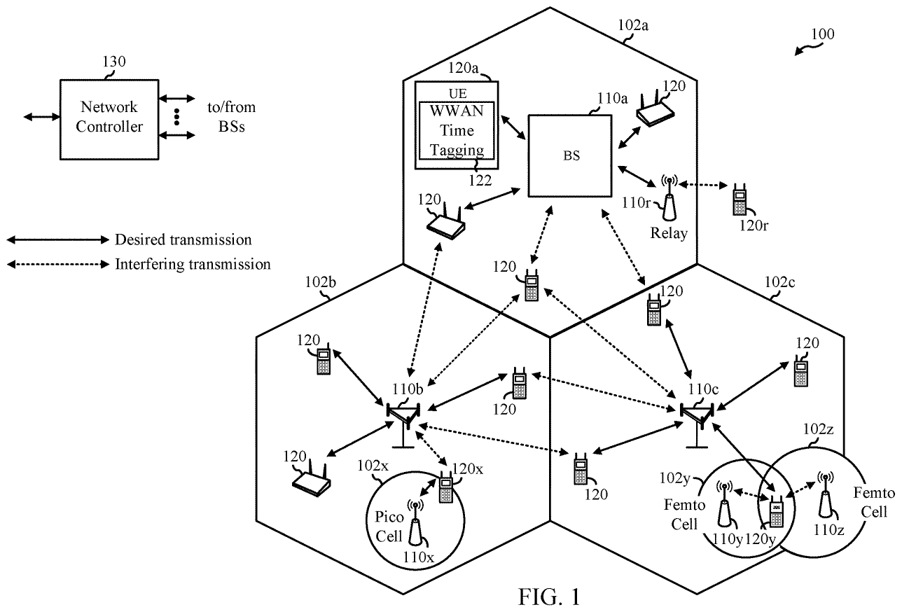

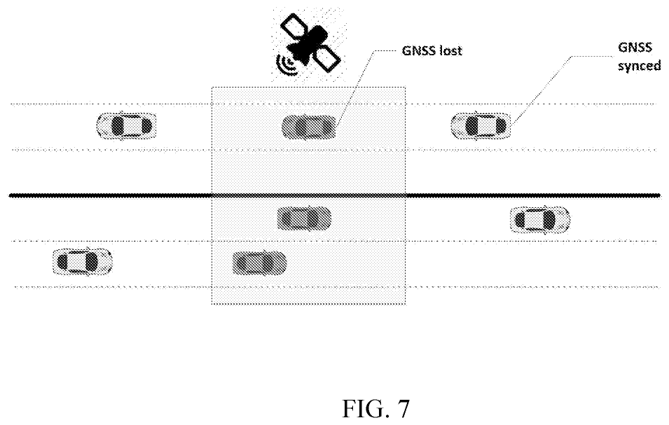

FIG. 1 illustrates an example wireless communication network 100 in which aspects of the present disclosure may be performed. For example, one or more UEs 120a of FIG. 1 may be configured to perform operations described below with reference to FIG. 7 to maintain sidelink timing synchronization when the UE is outside GNSS coverage area.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the UEs 120 may be configured to determine resources to use for sidelink communications (with another UE). As shown in FIG. 1, the UE 120a includes a sidelink manager 122. The sidelink manager 122 may be configured to transmit a sidelink communication to another UE, in accordance with aspects of the present disclosure (or to process such sidelink communications).

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

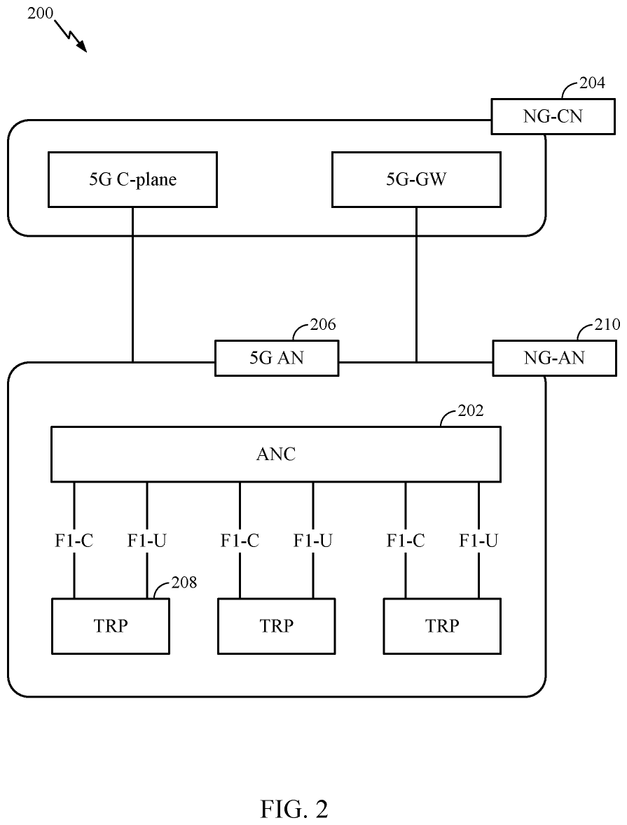

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

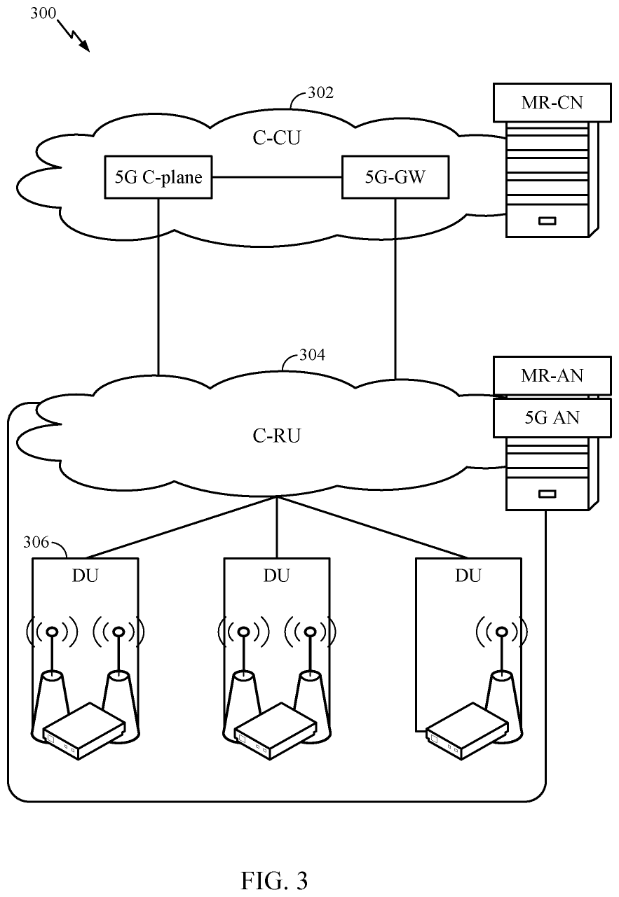

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

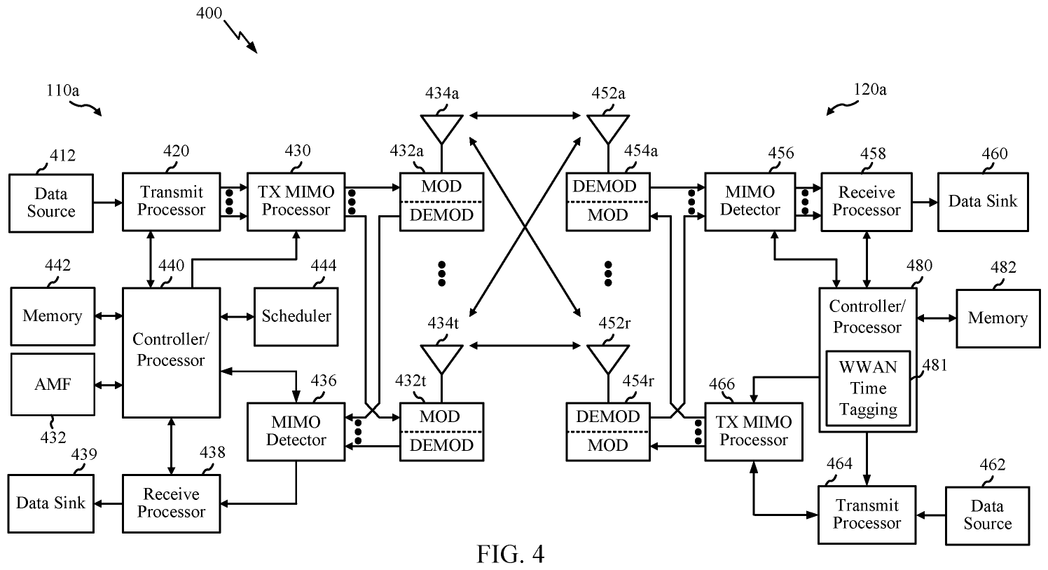

FIG. 4 illustrates example components of BS 110a and UE 120a (as depicted in FIG. 1), which may be used to implement aspects of the present disclosure. For example, antennas 452, processors 466, 458, 464, and/or controller/processor 480 of the UE 120a may be used to perform the various techniques and methods described herein with reference to FIG. 7 to maintain sidelink timing synchronization when the UE is outside GNSS coverage area.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120a, the antennas 452a through 452r may receive the downlink signals from the base station 110a and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the uplink, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110a. At the BS 110a, the uplink signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

The controllers/processors 440 and 480 may direct the operation at the BS 110a and the UE 120a, respectively. The processor 440 and/or other processors and modules at the BS 110a may perform or direct the execution of processes for the techniques described herein. As shown in FIG. 2, the controller/processor 480 of the UE 120a has a sidelink manager 481 that may be configured for transmitting a sidelink communication to another UE (or for processing such sidelink communications). Although shown at the controller/processor 480 and controller/processor 440, other components of the UE 120a and BS 110a may be used performing the operations described herein. The memories 442 and 482 may store data and program codes for BS 110a and UE 120a, respectively. A scheduler 444 may schedule UEs for data transmission on the downlink, sidelink, and/or uplink.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

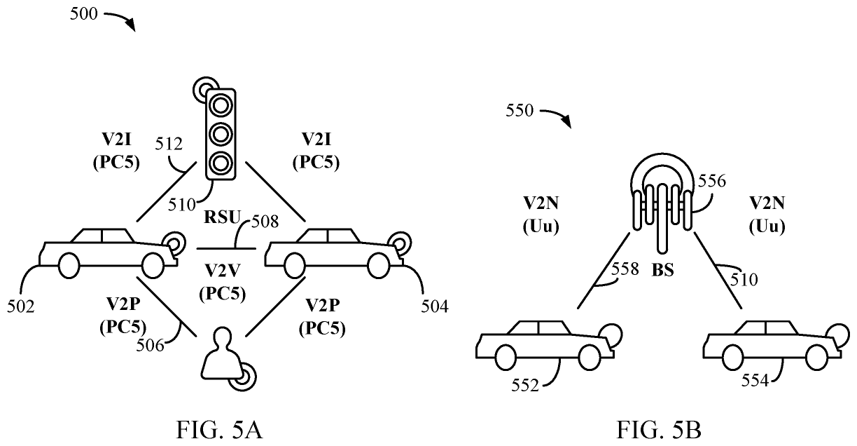

FIGS. 5A and 5B show diagrammatic representations of example vehicle to everything (V2X) systems in accordance with some aspects of the present disclosure. For example, the vehicles shown in FIGS. 5A and 5B may communicate via sidelink channels and may perform sidelink CSI reporting as described herein.

The V2X systems, provided in FIGS. 5A and 5B provide two complementary transmission modes. A first transmission mode, shown by way of example in FIG. 5A, involves direct communications (for example, also referred to as sidelink communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500 (for example, including vehicle-to-vehicle (V2V) communications) is illustrated with two vehicles 502, 504. The first transmission mode allows for direct communication between different participants in a given geographic location. As illustrated, a vehicle can have a wireless communication link 506 with an individual (i.e., vehicle to person (V2P), for example, via a UE) through a PC5 interface. Communications between the vehicles 502 and 504 may also occur through a PC5 interface 508. In a like manner, communication may occur from a vehicle 502 to other highway components (for example, roadside service unit 510), such as a traffic signal or sign (i.e., vehicle to infrastructure (V2I)) through a PC5 interface 512. With respect to each communication link illustrated in FIG. 5A, two-way communication may take place between elements, therefore each element may be a transmitter and a receiver of information. The V2X system 500 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. These network communications may occur through discrete nodes, such as a base station (for example, an eNB or gNB), that sends and receives information to and from (for example, relays information between) vehicles 552, 554. The network communications through vehicle to network (V2N) links 558 and 510 may be used, for example, for long-range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

In some circumstances, two or more subordinate entities (for example, UEs) may communicate with each other using sidelink signals. As described above, V2V and V2X communications are examples of communications that may be transmitted via a sidelink. When a UE is transmitting a sidelink communication on a sub-channel of a frequency band, the UE is typically unable to receive another communication (e.g., another sidelink communication from another UE) in the frequency band. Other applications of sidelink communications may include public safety or service announcement communications, communications for proximity services, communications for UE-to-network relaying, device-to-device (D2D) communications, Internet of Everything (IoE) communications, Internet of Things (IoT) communications, mission-critical mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes. In some examples, a sidelink signal may be communicated using a licensed spectrum (unlike wireless local area networks, which typically use an unlicensed spectrum).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

For the operation regarding PSSCH, a UE performs either transmission or reception in a slot on a carrier. A reservation or allocation of transmission resources for a sidelink transmission is typically made on a sub-channel of a frequency band for a period of a slot. NR sidelink supports for a UE a case where all the symbols in a slot are available for sidelink, as well as another case where only a subset of consecutive symbols in a slot is available for sidelink.

PSFCH may carry feedback such as channel state information (CSI) related to a sidelink channel quality. A sequence-based PSFCH format with one symbol (not including AGC training period) may be supported. The following formats may be possible: a PSFCH format based on PUCCH format 2 and a PSFCH format spanning all available symbols for sidelink in a slot.

### Example Enhancements of C-V2X Synchronization by WWAN Time Tagging

Aspects of the present disclosure provide apparatus, methods, processing systems, and computer readable mediums for synchronizing a UE's timing for sidelink communications with one or more other UEs. The techniques may be used, for example, in NR V2X systems to maintain sidelink timing synchronization when a UE is outside the coverage area of a synchronization source such as a global navigation satellite system (GNSS).

C-V2X communications typically require rather stringent synchronization between UEs. Synchronization may be based on various sources, such as GNSS, a serving cell or primary cell (PCell), or a synchronization reference signal sent on a sidelink (PC5) such as a sidelink synchronization signals (SLSS) or physical sidelink broadcast channel (PSBCH).

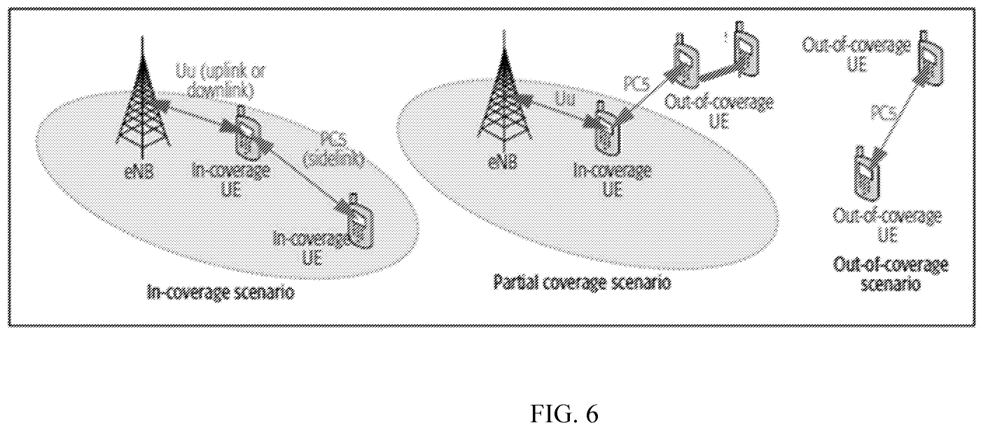

Various challenges exist for a C-V2X UE to maintain synchronization while in different coverage scenarios illustrated in FIG. 6. For example, in an in-coverage scenario (with all UEs in cell coverage), the UEs may be able to maintain synchronization for sidelink communications based on the (Uu) network connect. In a partial coverage scenario, where only some UEs are in coverage, the in-coverage UE may maintain synchronization with the network and assist out of coverage UEs in maintaining timing for sidelink communications. In an out-of-coverage scenario, however, it may be difficult for the UEs to maintain timing for sidelink communications.

As noted above, in some cases, GNSS may be used as a synchronization source for C-V2X UEs. In such cases, there may be certain requirements for transmission timing and frequency tracking. For example, UEs may be required to maintain transmission timing offset/uncertainty (T_{UNC}) of ±12*Ts (˜391 ns) of GNSS timing, after the UE has synchronized to the GNSS synchronization source, and to maintain a modulated carrier frequency uncertainty (F_{UNC}) of ±0.1 ppm of GNSS frequency.

As illustrated in FIG. 7, however, some C-V2X UEs may lose GNSS coverage and synchronization. During GNSS coverage outage, the C-V2X UE sidelink communications may be suspended due to the requisite accurate timing to operate physical layer procedures. In some cases, receive timing could be relaxed, but that may be left up to UE implementation.

Aspects of the present disclosure mechanisms that may allow V2X UEs to maintain sidelink timing synchronization even when outside the coverage area of a synchronization source such as a global navigation satellite system (GNSS).

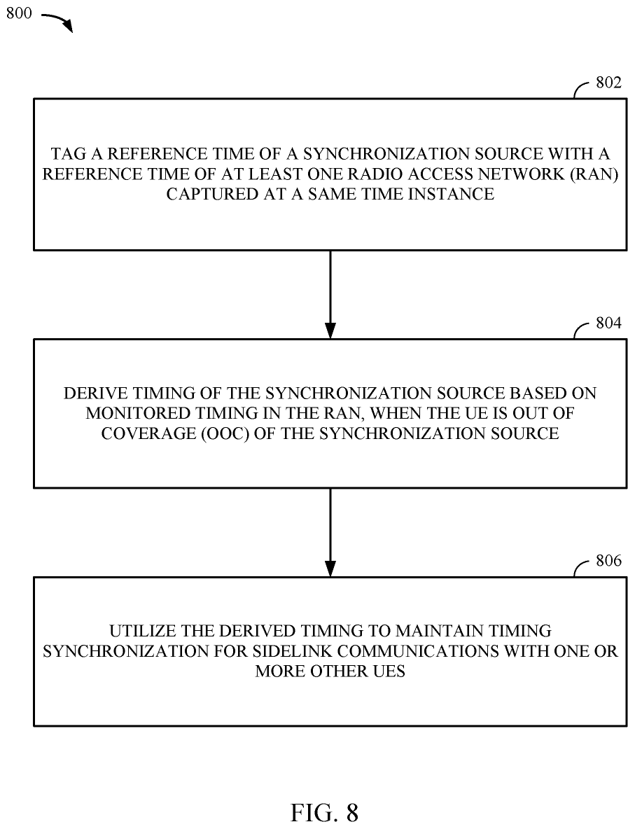

FIG. 8 illustrates example operations 800 for wireless communications by a UE, in accordance with certain aspects of the present disclosure. For example, operations 800 may be performed by a UE 120 of FIG. 1 or FIG. 4 to maintain timing synchronization for sidelink communications with one or more other UEs when out of coverage (OOC) of a synchronization source, such as GNSS.

Operations 800 begin, at 802, by tagging a reference time of a synchronization source with a reference time of at least one radio access network (RAN) captured at a same time instance. At 804, the UE derives timing of the synchronization source based on monitored timing in the RAN, when the UE is out of coverage (OOC) of the synchronization source. At 806, the UE utilizes the derived timing to maintain timing synchronization for sidelink communications with one or more other UEs.

Thus, by tagging the reference time of the synchronization source with the reference time of the RAN at the same time instance, a UE may maintain sidelink timing synchronization even when out of coverage of the synchronization source.

In some cases, this tagging, for C-V2X and WWAN concurrency UEs, may allow the UEs to effectively track GNSS timing even when the UE becomes out-of-coverage (OOC) of the GNSS if in coverage of LTE. For example, LTE has much wider coverage than GNSS.

Downlink timing of a synchronized WWAN (RAN) network may be desirable to maintain sidelink timing synchronization, due to a bounded timing drift. Time division duplexed (TDD) or some specific networks may be known to be synchronized. Cells with certain system information blocks (SIBS), such as SIB21, may also be known to be synchronized. For non-SIB21 LTE cells, SIB 8 or SIB 16 may provide universal time clock (UTC) timing information.

A reference time (based on DL timing) of such networks may be used to tag a reference time in GNSS and used to track the GNSS time when a UE is out of GNSS coverage, in order to maintain C-V2X timing. In such cases, the UE can use absolute eNB DL timing or, instead of absolute timing, the UE can use relative timing for C-V2X timing drift correction under GNSS OOC, as will be described in greater detail below.

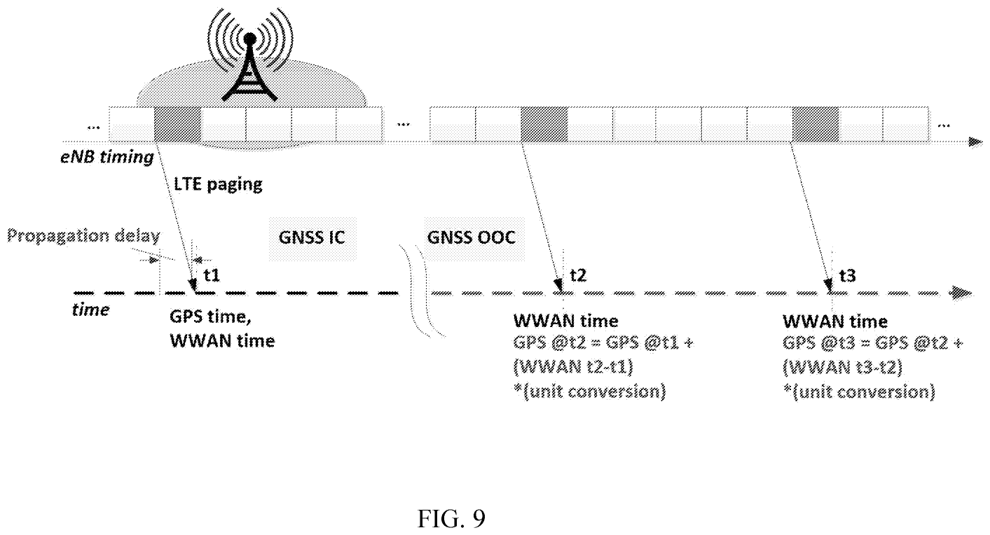

FIG. 9 graphically illustrates how a UE can derive GNSS timing by utilizing WWAN (LTE in this example) DL timing when the UE is OOC of the GNSS. As illustrated, while the UE is under GNSS coverage, at time t1, the UE may “tag” the GNSS time with a reference WWAN time captured at the same instance. Subsequently, the UE may be able to update GNSS time based on WWAN DL timing. For example, if the UE receives WWAN DL timing at time t_k, GNSS time at t_k may be derived as:

GNSS@t_k=(LTE t_k−t(k−1))×(LTE-to-GNSS unit conversion).

In the example illustrated in FIG. 8, the UE tags GNSS/GPS with WWAN/LTE timing at t1, thus GPS timing at times t2 and t3 may be derived as:

GPS@t2=GPS@t1+(WWAN t2−t1)*unit conversion; and

GPS@t3=GPS@t2+(WWAN t3−t2)*unit conversion.

WWAN time tagging based synchronization may be used in both Connected mode and Idle mode. For example, in Connected Mode, or connected discontinuous reception (CDRX), for example, in Connected Mode, the UE may update timing every 100 ms. In CDRX mode, the update period may be longer than in Connected Mode, for example, every CDRX On duration (which may be >100 ms). In Idle DRX (IDRX) mode, the UE may measure WWAN timing during paging IDRX, for example, based on LTE timing acquired every paging occasion (PO). During handover (HO), the tagged time may be reset and the GNSS time may be tagged with timing in the new cell.

In some cases, the UE may use a WWAN DL timing drift estimation for C-V2X timing, when GNSS is OOC. The UE may use such timing drift estimation to determine how much the WWAN timing may drift since GNSS reference time was tagged. For this purpose, synchronized networks may be considered, but the UE may use relative timing for drift correction, rather than absolute eNB DL timing.

In some cases, a UE may utilize eNB DL reference timing only when camped/connected in synchronized networks (e.g., where eNB timing drift is bound). In such cases, the UE may maintain a database of synchronized networks, for example, tracking area levels might be used for checking the NW synchronization. In some cases, the UE may also use frequency error correction provided by the WWAN (or an LTE frequency tracking loop-FTL), which may be a GNSS legacy feature. In such cases, LTE frequency error maybe maintained within a limit (e.g., less than 0.3 ppm).

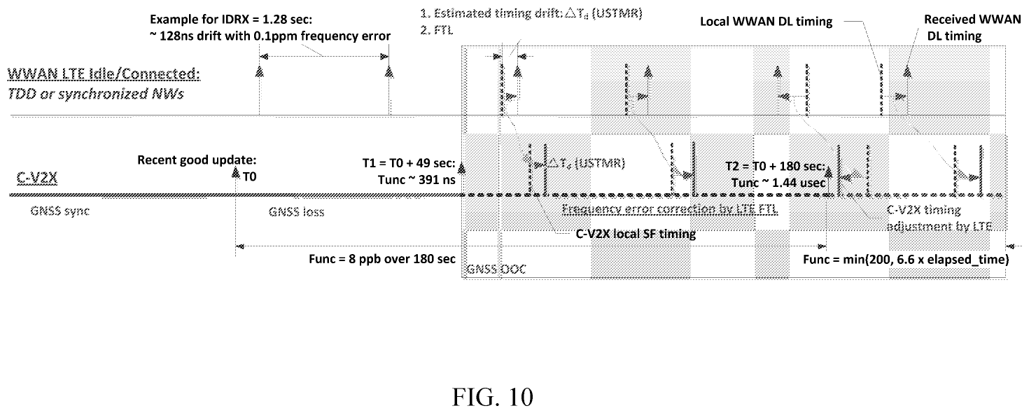

As illustrated in FIG. 10, after estimating timing drift in the WWAN, the UE may apply a timing adjustment to the derived GNSS time. For example, assuming an LTE time tagging difference of:

ΔT_{d}=t_{SF}^{received}−t_{SF}^{local};

the UE may adjust the V2X synchronized timing accordingly:

V2X t_{SF}^{local}+ΔT_{d}.

In some cases, a certain amount of mobility or propagation delay impact may be acceptable (e.g., ˜190 ns for a relatively high mobility of 160 km/h).

As noted, a UE may be preference to synchronized networks, for tagging GNSS timing. To assist in such efforts, the UE may need to detect synchronized networks. As noted above, TDD networks may be assumed to be synchronized. In other words, a UEs may enable eNB DL timing when the camps on synchronized TDD networks. In some cases, the UE may also be able to apply GNSS time tagging for networks that, while not synchronized, may be identified as having a bounded drift.

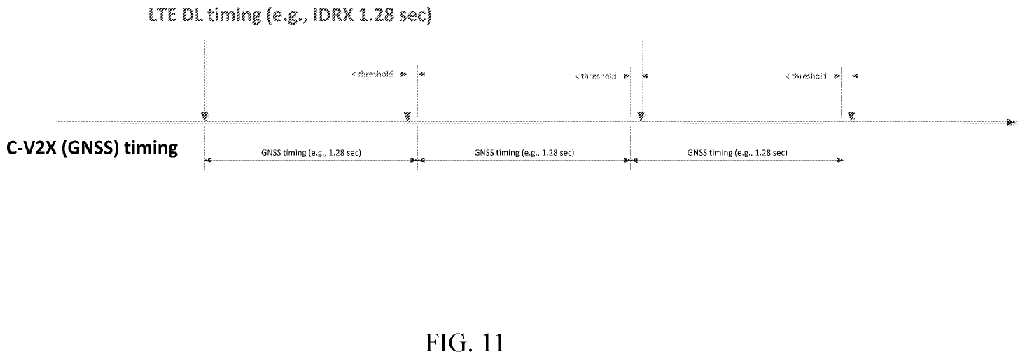

FIG. 11 illustrates how a UE may measure timing drift of a network, based on network DL timing relative to the GNSS timing. In such cases, the UE may measure the timing drift when the GNSS is In-sync and the UE is in LTE Idle/Connected mode. If the measured eNB DL timing drift is less than a threshold (e.g., X us), the UE may decide this network is suitable for deriving GNSS timing. On the other hand, if the measured eNB DL timing exceeds the threshold, the UE may not use this eNB DL timing as a synchronization source to maintain GNSS timing.

As noted above, the UE may track and maintain a database (or track with a policy manager) of which networks (e.g., cells identified by physical cell IDs) are synchronized (which may include networks with bounded timing drift). In some cases, for example, the UE may maintain a list of synchronized cells for a PLMN/tracking area or bands (TDD). As noted above, some networks may be known to be synchronized (e.g., TDD inter-cell synchronization requirements may mandate synchronization within various thresholds (e.g., ≤3 us for a medium cell and ≤10 us for a large cell. Additionally, some operators may have tighter synchronization requirements, at least within a given period (e.g., less than ±1.5 us in 24 hours). As noted above, the presence of SIB21 broadcasts also indicate synchronized cells. Based on the database information, the UE may enable eNB DL timing when the UE camps on synchronized cells (e.g., as identified by the PLMN/tracking area, bands).

It may also be useful to identify cells that are not synchronized (asynchronized cells) so the UE can drop these cells from the database/lists. In some cases, the UE maintain lists (referred to as blacklists) for asynchronous cells, for example, based on extended cell group identity (eCGI), locations,) that are identified among the synchronized (<PLMN/tracking area, bands (TDD)>) cells. For example, the UE may identify cells as asynchronous where the system frame number (SFN) jumps from one cell to another (even if SF boundaries align).

As proposed herein, if a UE determines (e.g., based on the maintained database/lists) that a network is synchronized with GNSS or that the timing drift is tightly limited (bounded), it may use downlink timing in the network to derive GNSS timing when out of GNSS coverage. If the UE does not find such a cell, it may fall back to a UE-assisted mode (e.g., relying on timing information from other UEs that may be in GNSS coverage).

How a UE maintains sidelink timing synchronization during a handover may depend on the source and target networks. For example, if the handover is between two synchronized networks, the UE may simply suspend a timing adjustment for some period of time (e.g., <1 sec) as some amount of disruption may be acceptable. If the handover is to an asynchronous network (e.g., whose drift is not bounded), the UE may fall back to the UE-assisted mode. Similarly, if the UE is OOC in WWAN (e.g., LTE), it may also fall back to the UE-assisted mode.

In some cases, the time tagging proposed herein may be enhanced by compensating for timing advancements (TA) in a network (e.g., to try and determine true network timing). For example, the UE may subtract the TA from the eNB DL timing as this effectively results in a propagation delay impact.

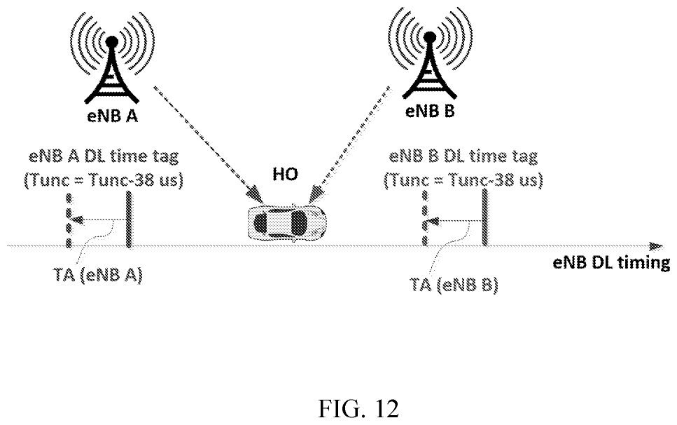

As illustrated in FIG. 12, the UE may remove the conservative uncertainty of propagation delay from time uncertainty (T_{UNC}) estimation. In some cases, the network may pass the TA information to a C-V2X UE. When the UE is in LTE Connected mode, in general, the TA (from the eNB) will be known. When the UE is in LTE Idle, it may trigger a mobile originated (MO) message (ping), for example, to transition to RRC CONNECTED periodically (this messaging may not be required when data activity is ongoing).

As proposed herein, by tagging the reference time of the synchronization source with the reference time of a RAN (e.g., LTE/NR) at the same time instance, a UE may be able to maintain sidelink timing synchronization, even when the is out of coverage of the synchronization source (e.g., when the UE is GNSS OOC).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIG. 7 may be performed by various processors shown in FIG. 4 for UE 120a.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a user equipment (UE), comprising:
tagging a reference time of a synchronization source with a reference time of at least one radio access network (RAN) captured at a same time instance;
deriving timing of the synchronization source based on monitored timing in the RAN, when the UE is out of coverage (OOC) of the synchronization source; and
utilizing the derived timing to maintain timing synchronization for sidelink communications with one or more other UEs.

2. The method of claim 1, wherein the derived timing is utilized to maintain timing synchronization for cellular vehicle to everything (C-V2X) communications, including at least one of vehicle-to-vehicle (V2V), vehicle-to-infrastructure (V2I), or vehicle-to-pedestrian (V2P) communications.

3. The method of claim 1, wherein:
the RAN comprises at least one of a long term evolution (LTE) RAN, a new radio (NR) RAN, a code division multiple access (CDMA) RAN, a global system for mobile communication (GSM) RAN, or other wireless wide area network (WWAN); and
synchronization source comprises a global navigation satellite system (GNSS).

4. The method of claim 1, wherein:
the monitored timing in the RAN is updated based on periodically or aperiodically transmitted downlink signals in the RAN.

5. The method of claim 4, wherein how often the monitored timing in the RAN is updated depends, at least in part, on whether the UE is in a connected or idle mode.

6. The method of claim 5, wherein the monitored timing in the RAN is updated:
during ON durations when the UE is in a connected discontinuous reception (C-DRX) mode; or
during paging opportunities (POs) when the UE is in an idle DRX (I-DRX) mode.

7. The method of claim 1, further comprising tagging a new reference time of the synchronization source with a reference time of the RAN after a handover of the UE to a different cell of the same RAN or to a different RAN.

8. The method of claim 1, further comprising:
estimating drift in the RAN timing; and
compensating the derived time based on the estimated drift.

9. The method of claim 8, wherein the UE derives timing of the synchronization source based on monitored timing in the RAN, only when the estimated drift is within certain bounds.

10. The method of claim 8, wherein the drift is estimated based, at least in part, on a frequency error correction provided by the RAN.

11. The method of claim 1, further comprising:
detecting one or more synchronized RAN cells to use for deriving timing of the synchronization source, when the UE is OOC of the synchronization source.

12. The method of claim 11, wherein cells are detected as synchronized based on:
the cells utilizing time division duplexing (TDD); or
the cells being identified as having a bounded timing drift.

13. The method of claim 12, wherein the cells are detected as synchronized based on the presence or content of one or more types of system information blocks (SIBs).

14. The method of claim 11, further comprising maintaining a list of synchronized cells.

15. The method of claim 14, wherein the list identifies synchronized cells based on at least one of public land mobile network (PLMN), tracking area, band, or level of synchronization.

16. The method of claim 14, further comprising:
detecting a cell as asynchronized with other cells; and
preventing or dropping the asynchronized cell from the list.

17. The method of claim 16, further comprising maintaining a blacklist of asynchronized cells.

18. The method of claim 16, further comprising tagging a reference time of a synchronization source with a reference time of an asynchronized cell, if that cell is synchronized with the synchronization source or timing drift for the asynchronized cell is limited.

19. The method of claim 14, further comprising at least temporarily suspending deriving timing of the synchronization source when the UE is handed over between synchronized cells.

20. The method of 1, further comprising compensating the derived timing for at least one of:
timing advance (TA) in the RAN; or
uncertainty in propagation delay.

21. The method of claim 20, wherein the UE periodically transitions from an idle mode to a connected mode to obtain information regarding the TA.

22. An apparatus for wireless communications by a user equipment (UE), comprising:
means for tagging a reference time of a synchronization source with a reference time of at least one radio access network (RAN) captured at a same time instance;
means for deriving timing of the synchronization source based on monitored timing in the RAN, when the UE is out of coverage (OOC) of the synchronization source; and
means for utilizing the derived timing to maintain timing synchronization for sidelink communications with one or more other UEs.

23. An apparatus for wireless communications by a user equipment (UE), comprising:
at least one processor and a memory configured to
tag a reference time of a synchronization source with a reference time of at least one radio access network (RAN) captured at a same time instance;
derive timing of the synchronization source based on monitored timing in the RAN, when the UE is out of coverage (OOC) of the synchronization source; and
utilize the derived timing to maintain timing synchronization for sidelink communications with one or more other UEs.
